(19) United States
(12) Patent Application Publication
(10) Pub. No.: US 2010/0137096 A1
(43) Pub. Date: Jun. 3, 2010

(54) COMPONENT HAVING INNER AND OUTER GEARING

(75) Inventors: Dietmar Illerhaus, Friedrichshafen (DE); Alfred Skrabs, Sitterswald (DE); Gert Hanker, Meckenbeuren (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/598,468

(22) PCT Filed: Apr. 24, 2008
(86) PCT No.: PCT/EP08/54962

§ 371 Date: Nov. 2, 2009

(30) Foreign Application Priority Data
May 5, 2007 (DE) 10 2007 021 194.7

(51) Int. Cl. F16H 1/28; F16H 55/17

(52) U.S. Cl. 475/331

(57) ABSTRACT

The invention relates to a component (4) having inner teeth (4a) and outer teeth wherein the component (4) is configured at least partially as a hollow cylindrical base body (4b) on which the inner teeth and outer teeth are disposed.

It is recommended that one of the two sets of teeth, particularly the inner teeth (4a), be configured as one piece with the base body (4b) and the other set of teeth, particularly the outer teeth, be configured as an added part (6), which can be joined to the base body (4b).

This application is a National Stage completion of PCT/EP2008/054962 filed Apr. 24, 2008, which claims priority from German patent application serial no. 10 2007 021 194.7 filed May 5, 2007.

### FIELD OF THE INVENTION

The invention relates to a component having inner and outer teeth.

### BACKGROUND OF THE INVENTION

Components having inner and outer teeth are known, for example, as ring gears of planetary gears in an automatic transmission for motor vehicles. Such ring gears have inner teeth in which planet wheels of the planetary gear revolve. In addition, the known ring gears feature synchronization teeth at the outer circumference, in which inner disks of a shift element of the automatic transmission engage. Such a ring gear is shown in FIG. 1 of an older patent application by the applicant with the number 102 006 031 788. An oil feeder hole is provided, which extends in the longitudinal direction or obliquely to the longitudinal direction, in order to supply the shift element, between the inner and outer teeth, with oil. Since both the outer and inner teeth are produced by machining, the manufacturing costs are relatively high.

### SUMMARY OF THE INVENTION

It is the object of the present invention to improve a component of the type mentioned above with respect to the manufacturing costs thereof.

According to the invention, one of the two sets of teeth, particularly the inner teeth, is configured as one piece with the base body of the component, and the other set of teeth, particularly the outer teeth, is configured as an added part, which can be joined to the base body. As a result of the two-part joining design according to the invention, the advantage is achieved that one of the two sets of teeth, particularly the outer teeth, does not need to be manufactured by machining, but can be produced more cost-effectively as a separate part.

According to an advantageous embodiment, the added part is designed as a sheet metal part which can be produced by forming, preferably from a steel sheet billet. In this way, the outer teeth can be produced more cost-effectively by a known metal forming method and placed like a collar onto the base body of the component.

In a further advantageous embodiment, the outer teeth are designed as synchronization teeth for a clutch pack, particularly as a disk carrier for the inner disks of a shift element. Such catch profiles, which typically have a trapezoidal shape, can be produced inexpensively by metal forming. In addition, the two-part joining design, according to the invention, produces weight advantages. The channels running in the longitudinal direction, between the catch profile and the base body, can be used as lubricating oil channels.

The component is preferably configured as a ring gear of a planetary gear, which interacts with a shift element of an automatic transmission by way of the outer or synchronization teeth.

The base body preferably has a substantially cylindrical outer surface, onto which the sheet metal part, having the catch profile, is slid and fixed in the axial direction. For this purpose, the base body has at least one stop surface and the sheet metal part has at least one fixing element. Preferably, a first fixing element can already be prefabricated in the sheet metal part, for example, as a cut inwardly pushed nose which rests against the base body at the front.

Preferably, a second fixing element can be provided on the sheet metal part which, after installation which is to say after joining the sheet metal part with the base body, is bent such that it causes an axial fixation of the sheet metal part relative to the base body.

In an advantageous embodiment, the fixing elements can be produced by punching. In this way, cost and weight advantages are achieved for the component according to the invention, since only one set of teeth, preferably the inner teeth, is produced by machining, and the other set of teeth, preferably the outer teeth, can be produced using a non-cutting method, which is to say by metal forming. The joining process for connecting the base body to the component requires no additional fixing elements, since these are provided on the sheet metal part.

### BRIEF DESCRIPTION OF THE DRAWINGS

An exemplary embodiment of the invention is illustrated in the drawings and described in more detail hereafter, wherein:

FIG. 1 is a section of an automatic transmission comprising a ring gear according to the invention, and

FIG. 2 is a perspective illustration of the ring gear comprising synchronization teeth configured as a metal-formed part.

### DETAILED DESCRIPTION OF THE PREFERRED EMBODIMENTS

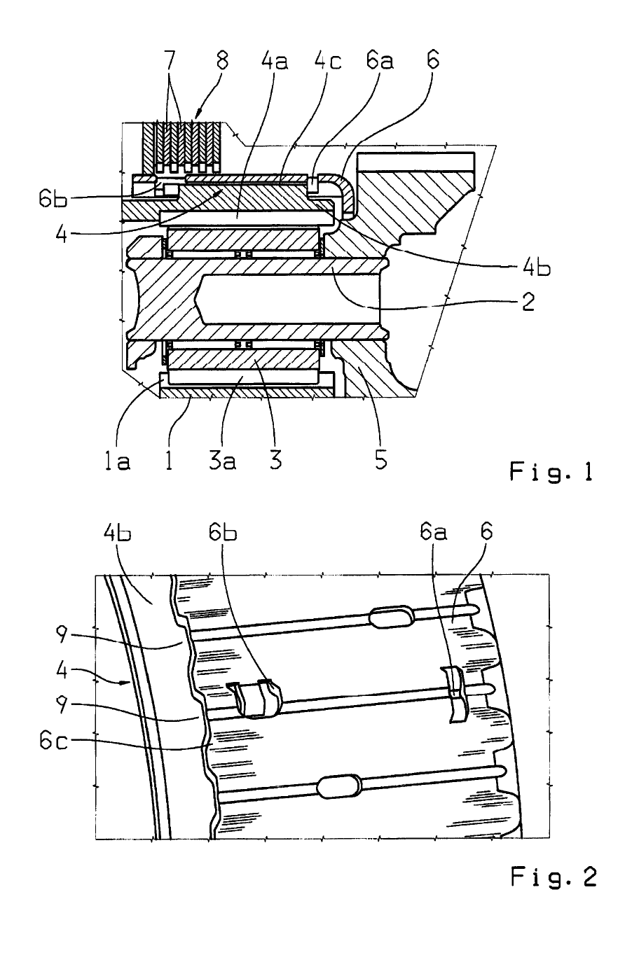

FIG. 1 shows a section of an automatic transmission of a motor vehicle wherein parts of a planetary stage, which is to say a sun gear 1, a planet wheel 3 supported on a planetary pin 2, and a ring gear 4, are illustrated. The planet wheel 3 has outer teeth 3a, which are engaged with outer teeth 1a of the sun gear 1 and inner teeth 4a of the ring gear 4. The planetary pin 2 is accommodated in a planet carrier 5. The ring gear 4 has a base body 4b, which is designed as one piece with the inner teeth 4a which are produced by machining. The base body 4b has a substantially cylindrical outer surface 4c onto which an added part 6, configured as a formed sheet metal part, is slid. The formed sheet metal part 6 comprises synchronization teeth (see also FIG. 2), in which inner disks 7 of a clutch pack 8 of a shift element, which is not shown completely, engage. The ring gear 4 is, therefore, engaged with both the planet wheel 3 and the inner disks 7 such that the ring gear 4, for example, can be decelerated or fixed. The formed sheet metal part 6 has a first fixing element 6a, which is supported on a front stop surface of the planet wheel 3, and a second fixing element 6b, which rests against the opposite front of the planet wheel 3. The first fixing element 6a is prefabricated, while the second fixing element 6b is only bent after installation of the formed sheet metal part 6. The first and second fixing elements 6a, 6b secure the formed sheet metal part 6 on the base body 4b of the ring gear 4 in both axial directions. The formed sheet metal part 6 can be secured non-positively or positively in the circumferential direction.

FIG. 2 shows, in a perspective illustration, the ring gear 4 with a view of the formed sheet metal part 6, which comprises outer teeth configured as a catch profile 6c having an approximately trapezoidal cross-section. The first fixing element 6a is configured as a cut, inwardly pushed nose, which is already provided before installation of the formed sheet metal part 6. The formed sheet metal part 6 is slid in the axial direction, onto the base body 4b, until the nose 6a abuts against the stop. Then, the second fixing element 6b, which is configured as a cut-in tab, is bent inwardly and secures the formed sheet metal part 6 in the other axial direction. The formed sheet metal part 6 is thus configured as a disk carrier for the inner disks of the shift element. Between the base body 4b, which has a substantially cylindrical circumferential surface 4c, longitudinal channels 9 are formed by the catch profile 6c, by which the oil can be supplied to the clutch pack 8.

Reference numerals

| | |
|---|---|
| 1 | Sun gear |
| 1a | Outer teeth |
| 2 | Planetary pin |
| 3 | Planet wheel |
| 3a | Outer teeth |
| 4 | Ring gear |
| 4a | Inner teeth |
| 4b | Base body |
| 4c | Cylindrical outer surface |
| 5 | Planet carrier |
| 6 | Added part/formed sheet metal part |
| 6a | 1st fixing element/nose |
| 6b | 2nd fixing element/tab |
| 6c | Catch profile/outer teeth |
| 7 | Inner disk |
| 8 | Clutch pack |
| 9 | Longitudinal channels |

1-13. (canceled)

14. A ring gear (4) of a planetary stage of a planet gear, the ring gear (4) comprising:
a base body (4b) with inner teeth (4a), and the base body (4b) and the inner teeth (4a) being configured as one piece,
wherein the base body (4b) has a substantially cylindrical outer surface (4c) and an added part (6) is disposed on the outer surface (4c), and
the added part (6) has outer teeth configured as a catch profile (6c).

15. The ring gear (4) according to claim 14, wherein the added part (6) is configured as a sheet metal part produced by a forming process.

16. The ring gear (4) according to claim 14, wherein the outer teeth (6c) are configured as a catch profile for a clutch pack (8).

17. The ring gear (4) according to claim 14, wherein the base body (4b) has stop surfaces and the sheet metal part (6) has fixing elements (6a, 6b) by which the sheet metal part (6) is secured, in the axial direction, relative to the base body (4b).

18. The ring gear (4) according to claim 17, wherein the stop surfaces are disposed on a front of the ring gear (4).

19. The ring gear (4) according to claim 17, wherein a first fixing element (6a) is prefabricated at the sheet metal part (6).

20. The ring gear (4) according to claim 19, wherein the first fixing element (6a) is produced by a punching process.

21. The ring gear (4) according to claim 19, wherein the first fixing element is configured as an inwardly pushed nose (6a).

22. The ring gear (4) according to claim 17, wherein a second fixing element (6b) is produced by one of during and after installation of the sheet metal part (6).

23. The ring gear (4) according to claim 22, wherein the second fixing element (6b) is produced by bending partial regions of the sheet metal part (6).
